(19) United States
(12) Patent Application Publication
(10) Pub. No.: US 2016/0302390 A1
(43) Pub. Date: Oct. 20, 2016

(54) Special Search Dog Pack and Process for Faster Dog-Only Search

(71) Applicant: Dann M. Allen, Hartford City, IN (US)

(72) Inventor: Dann M. Allen, Hartford City, IN (US)

(21) Appl. No.: 15/098,809

(22) Filed: Apr. 14, 2016

Related U.S. Application Data
(63) Continuation-in-part of application No. 62/147,010, filed on Apr. 14, 2015.

(51) Int. Cl. A01K 27/00; A01K 11/00

(52) U.S. Cl. CPC A01K 27/008; A01K 11/008

(57) ABSTRACT

This device is a Special Search Dog Pack and Process for Faster Dog-Only Search. Particularly this search pack device with specific rescue contents and is related to a faster search means wherein the search dog has an attached pack with the rescue contents that can be carried directly to a victim without the need of an attending person. Once found the victim can communicate back to a search party and/or the search party may quickly and accurately locate the victim for a more precise and faster rescue.

### CROSS-REFERENCE TO RELATED APPLICATIONS

This application claims the benefit of United States Provisional Patent Application Ser. No. 62/147,010 filed Apr. 14, 2015 by Dann M. Allen and entitled “Special Search Dog Pack and Process for Faster Dog-Only Search”.

### FIELD OF INVENTION

This invention relates to a Special Search Dog Pack and Process for Faster Dog-Only Search. Particularly this search pack device/product and process is related to a faster search means wherein the search dog has an attached pack with contents that may be carried directly to a victim without the need of an attending person. Once found the victim may communicate back to a search party and/or the search party may quickly and accurately locate the victim for a more precise and faster rescue.

### FEDERALLY SPONSORED RESEARCH

None.

### SEQUENCE LISTING OR PROGRAM

None.

### BACKGROUND

### Field of Invention and Prior Art

### Background and Problem Solved

As far as known, there are no Special Search Dog Pack and Process for Faster Dog-Only Search or the like. It is believed that this product and process are unique in its design and technologies.

When one is out hiking and then realizes he has passed the same dead tree for the third time, and sundown is 20 minutes away, a dog looking for a game of tug-of-war might be his best chance at making it home. Search-and-rescue dogs are smart, agile and obedient, but their high “play drive” is what makes them look for a missing person through snow and rain, down steep rock walls and in crevices that would make a claustrophobic run screaming. At its most basic, the job of a SAR dog has two components: First—Find the origin of a human scent and let the handler know where it is. So how do S-A-R Dogs work? All humans, alive or dead, constantly emit microscopic particles bearing human scent. Millions of these are airborne and are carried by the wind for considerable distances. The air scenting SAR dog is trained to locate the scent of any human in a specific search area. The dog is not restricted to the missing person's track and can search long after the track is obliterated. Many air scenting search dogs are also trained in trailing/scent discrimination.

Upon arrival at the search site, dog handlers normally work directly for their unit's operations leader, who reports to the local search boss or incident commander of the local agency. Many units provide their own base camp operation, with trained radio operators, SAR dog advisors, and other support personnel.

Second, after the initial hasty searches of trails and paths, each dog/handler team is usually assigned a segment of the overall search area to cover systematically. Dog handlers work their dogs downwind of the section assigned to them or cover the area in a way that provides dogs with the best scenting coverage. Handlers map the area they have covered and report their POD (probability of detection) to the plans section or operations leader upon completing their assignments.

Search dogs can work in areas where other searchers have been, and they can work with other search resources, such as man-trackers. Using scent articles, they can discriminate for the missing person in heavily populated areas. They can work day or night, in most kinds of weather, and are especially effective where human sight is most limited—in the dark, in dense woods or heavy brush, in debris (as found in earthquakes, floods, and tornadoes) and under water.

Experts estimate that a single SAR dog can accomplish the work of approximately 20 to 30 human searchers. It's not just about smell either—a dogs' superior hearing and night vision also come into play. Time is always an issue in search and rescue. In an avalanche situation, for instance, approximately 90 percent of victims are alive 15 minutes after burial; upon 35 minutes after burial, only about 30 percent of victims are alive. While most avalanche victims don't survive, their chances increase exponentially when dogs are a part of the search. Even in cases where victims are presumed dead, dogs are invaluable assets—they locate the bodies so family members can have closure and give their loved one a proper burial.

SAR dogs can do a lot of amazing things, including rappel down mountainsides with their handler, locate a human being within a 500-meter radius, find a dead body under water, climb ladders and walk across an unstable beam in a collapsed building, but it's all toward a single end-find and identify the location of a victim.

While some dogs exhibit a stronger desire to scent than others, every canine out there has a powerful sense of smell. SAR dogs may be purebreds or mutts. Some handlers have a breed of choice, but any medium-to-large dog in good physical health, with decent intelligence, good listening skills, a non-aggressive personality and a strong play/prey drive (an intense, enduring desire to retrieve a toy) can potentially go into search and rescue. SAR dogs need to be big enough to successfully navigate treacherous terrain and push debris out of the way and yet small enough to transport easily. You actually don't find too many Saint Bernard search dogs these days, because they can be cumbersome. German shepherds are a popular SAR breed—they're typically smart, obedient and agile, and their double-layered coat insulates against severe weather conditions. Hunting and herding dogs like Labrador and golden retrievers and border collies tend to be good at SAR work, too, because they have a very strong prey drive. Many people consider bloodhounds to be the best breed for tracking—their giant ears and facial folds serve to collect and concentrate scent particles right at their nostrils, making their sense of smell extremely powerful and discerning. A bloodhound can pick up a trail weeks after other breeds can't find it. This brings us to a distinction between types of SAR dogs: Some dogs track, while other dogs search.

Not all SAR dogs perform the same type of search. Some dogs are tracking (or trailing) dogs, and others are air-scent (or area-search) dogs. The types overlap, but the distinction between the two guides are the training process and how the dog participates in missions. Tracking dogs work with their nose to the ground. They follow a trail of human scent—typically heavy skin particles that fall quickly to the ground or onto bushes—through any type of terrain. These dogs are not searching, they're following: Tracking dogs need a “last seen” starting point, an article with the person's scent on it to work from and an uncontaminated trail.

For tracking, time is an issue. If a child disappears from a school playground or an inmate escapes from a prison, a tracking dog might be called in to follow the person's scent immediately after the disappearance, before other search groups and law-enforcement personnel contaminate the scent trail.

Air-scent dogs, on the other hand, work with their nose in the air. They pick up human scent anywhere in the vicinity—they don't need a “last seen” starting point, an article to work from or a scent trail, and time is not an issue. Whereas tracking dogs follow a particular scent trail, air-scent dogs pick up a scent carried in air currents and seek out its origin—the point of greatest concentration. Air-scent dogs might be called in to find a missing hiker located “somewhere in a national park,” an avalanche victim beneath 15 feet of snow or people buried under a collapsed building. Air-scenters might specialize in a particular type of search.

Scientist believe today's German shepherd are more closely related to the Asian wolf. So, How far can wolves travel? Wolves are hunters, and they travel far and wide to locate prey. They may travel 50 miles or more each day in search of food, and they are superbly designed for a life on the move. Because their elbows turn inward, their lean bodies are precisely balanced over their large feet. With their long legs and ground-eating stride, they can travel tirelessly for hours on end with no energy wasted. Dispersing wolves, those leaving packs in search of their own mates, have been known to travel hundreds of miles away from their home territory. Satellite and Global Positioning Satellite (GPS) collars allow researchers to document the truly remarkable travels of wolves. How fast can wolves run and how far do they travel? Wolves trot at 5 miles per hour, but they can run in short bursts at up to 35 miles per hour. They can travel as much as 30 miles per day hunting for food.

### Problem Solved

As discussed above, SAR animals work well at quickly finding the victims. However the limitations of just finding a victim are: the time lost for the rescue team to catch-up to the dog or to penetrate or overcome the terrain—rocky cliffs, water, thickets and difficult ravines. What is needed is a way to immediately target the location, provide food and liquids, provide communication and provide warmth or a buffer from the weather and temperatures. The Special Search Dog Pack and Process for Faster Dog-Only Search solves these shortcomings in the SAR process as will be discussed in the following summary, description and operation.

### Prior Art

As far as known, there are no Special Search Dog Pack and Process for Faster Dog-Only Search or the like. Other search dog patents are few. A Chinese patent CN204766196U teaches a first that relates to dogs first-aid kit are equipped to policeman work technique of patrol dog. The utility model discloses by the medicine, surgical instruments, oxygen therapy equipment triplex, adopt the portable aluminum alloy box body, the high 170 mm of long 515 mm, the 370 wide mm of box, the box uses aluminum alloy extrusions as the skeleton, orange fire proof board material is pasted on the surface, is furnished with a English handle, two barbecue locks, two six hinges, limit and minute do not use packet strip and cornerite to consolidate, it is equipped with pocket and elastic cord to go up the cap rock in the box, the intermediate layer is slight high density fiberboard, the built-in EVA foamed material who has various customized shapes of bottom. This does not show or anticipate the Allen application.

Another disclosure is CN105044751A that shows and demonstrates a police dog rescue and state monitoring system based on big dipper, which solves the problem that the police dog positioning function of the prior art is unitary. The police dog rescue and state monitoring system based on big dipper disclosed by the invention comprises a central control station and an information module; the central control station consists of an antenna reception unit, a spectrum-spreading reception unit, an upper computer, a monitoring software and a central control station power supply module; the antenna reception unit is connected to the spectrum-spreading reception unit; the spectrum-spreading reception unit is connected to an upper computer; the monitoring software is installed on the upper computer; the information collection module consists of a big dipper navigation positioning module, a temperature sensor, a breath sensor, a micro-camera, a wireless emission module, a spectrum-spreading transmission module and an information collection power supply module; the big dipper navigation positioning module, the temperature sensor, the breath sensor and the micro-camera are connected to the wireless emission module; and the wireless emission module is connected to the antenna reception unit of the central control station through the spectrum-spreading module. It shows a position sensor but not rescue items and communication means for the victim.

U.S. Pat. No. 7,602,302 shows embodiments that provide a tracking apparatus and method that are operable to efficiently track an animal. The tracking apparatus is operable to be worn by an animal, determine its current geographic location, and transmit information relating to its current geographic location to an external device such as a portable navigation unit. The navigation unit is operable to display a representation of the geographic location of the tracking apparatus for consideration by a user. This fails to show the emergency supplies for the victim as demonstrated by the Allen device and system. As far as known, there are no Special Search Dog Pack and Process for Faster Dog-Only Search or the like.

### SUMMARY OF THE INVENTION

This invention is a Special Search Dog Pack and Process for Faster Dog-Only Searches. The preferred embodiment of the Special Search Dog Pack and Process for Faster Dog-Only Search is comprised of a special set of product encompassed in the search pack. These are useful and need to be with an SAR dog independent of an immediate dog handler. The SAR pack contains a group of contents from the group consisting of:

| | | Light | Heavy |
|---|---|---|---|
| | | Weight | Weight |
| | | Option | Option |
| Item | Description Option | ounces | ounces |
| | Water pouch with | | |
| | gravity water filter | | |
| 1 | water | 32 | 34 |
| 2 | filter | 2.4 | 17 |
| 3 | Power bars | 2.29 | 2.29 |
| 4 | Water proof matches | 0.45 | 1 |
| 5 | Space blankets. 84″ × | 2.88 | 10 |
| | 56″ | | |
| 6 | Satellite phone | 7.1 | 7.68 |
| 7 | Signal with human only | 3 | 10 |
| | activated switch | | |
| 8 | Sun screen | 1 | 2 |
| 9 | Salt | 0.1 | .25 |
| 10 | Some first aid | 3 | 13 |
| 11 | Scent-proof bag | 1 | 2 |
| 12 | Flashlight | 2 | 5 |
| 13 | Head cover | 2.5 | 2.5 |
| 14 | Person/s info being | 0.1 | 1 |
| | sought | | |
| 15 | Bug repellent | 1 | 1 |
| 16 | Dog backpack | 16 | 32 |
| 17 | Lighter | 0 | 2 |
| 18 | razor knife | 0 | 1.7 |
| 19 | Signal device for dogs | 0 | 10 |
| | to follow | | |
| Total | Ounces—oz. | 76.82 | 154.42 |
| Total | Pounds—Lbs. | 4.8 | 9.625 |

An alternative embodiment is a scent dog pack, with a unique scent for other dogs to pick up without attracting other unwanted animals and/or masking a dog scent. The unique scent would be a scent easy to follow so that the dogs can travel faster to join up with fellow dogs. Example; Used when an article belonging to a lost person is found in an area where one dog was assigned to, the other dogs would be called off of their areas and sent to the found arctic area. The incoming dogs could easily pick up the unique smell/s left from the dog in the item area.

The newly invented Special Search Dog Pack and Process for Faster Dog-Only Search may be manufactured or assembled at low volumes by very simple means and in high volume production by more complex and controlled systems.

### OBJECTS AND ADVANTAGES

There are several objects and advantages of the Special Search Dog Pack and Process for Faster Dog-Only Searches for lost victims. There are currently no known Special Search Dog Pack and Process for Faster Dog-Only Search that are effective at providing the objects of this invention.

A dog can cover more ground with better sensory perception than the humans. While humans are pulling on the dog's leash, at the same time, the dog is pulling back, wearing both handler and dog out sooner. Look at all the photos with a dog and leash, the leash is pulled tight, the dog is pulling the handler, and the handler is pulling back too, wasting energy for both.

When someone/s is deemed missing, one person can send out many dogs to the last known area of the missing person/s in almost any weather and time of day. The search dogs would be carrying backpacks with very important essentials (to be determined by R&S from that area) to the missing person/s quicker than S&R personnel can. The essentials would help with saving life and/or limb. This will be done as a first step while the S&R is getting ready and informed. The dog's pack would also carry important transmission devices to help with the location of person/s missing. Some controls on the devices could only be controlled by humans only to help with false alarms. The search dogs would not need to:
be briefed,
wait to sunrise,
waiting for better weather and so on.

The dog's main objective would be to find the missing person/s and deliver the contents of its backpack to the missing person/s. At that time it would be up to the handler if the dog should return or stay with the found person/s. Finding the missing person/s may be found in good condition just feet from the trail and no R&S may be required at all by talking the found person/s back to the trail/terminal. When the dog finds the missing person/s by stopping for a predetermined time, and no signal is sent back to handler by human controlled transmitter, then the remote satellite phone's camera can be turned to survey the area. If a person is trapped up in a tree by a wild animal, then the R&S team would know to bring the proper equipment. If the satellite phone's camera is turned on and the person/s that are obviously expired then a SAR team may not be required.

When watching videos of SAR with dogs, it seems that the dogs are pulling against the trainer while the trainer is pulling back expending unneeded energy from both dog and handler. The dogs seem, to me to be able to leave the trainer far behind while staying on the scent. With this invention:
The backpacks would be preloaded and ready to be put on the dogs in seconds then loaded into the transport. (See contents)
Dog's pack easily converts into fanny pack for humans.
The dogs would be transported to where someone was missing.
The dogs would be given a scent or find a scent and then let loose.
The dogs could be given commands. (See commands).

Plus: the
Pouch converts into a fanny pack for humans.
Command signals for dogs.
A unit that only a humans can turn on.
A signal that is given off when a dog has been at certain location for predetermined amount of time.
Remote activated satellite phone camera and video.
A clear protective pouch in/on dog's pouch for the satellite phone.
Loaded with essentials

Typical Pouch Contents:
Water pouch with gravity water filter
   Water and filter
Power bars
Water proof matches
Space blankets. 84″×56″
Satellite phone
Signal with human only activated switch
Sun screen
Salt
Some first aid
Scent-proof bag
Flashlight
Head cover
Person/s info being sought
Bug repellent
Dog backpack
Lighter
razor knife and a
Signal device for dogs to follow.

The Special Search Dog Pack and Process for Faster Dog-Only Search may decrease the rescue time and thus increase the chance of a successful rescue of various victims. Finally, other advantages and additional features of the present Special Search Dog Pack and Process for Faster Dog-Only Search device and process will be more apparent from the accompanying drawings and from the full description of the device. For one skilled in the art of search and rescue devices and processes, especially involving dogs, it is readily understood that the features shown in the examples with this product are readily adapted to other types of search and rescue pack devices or contents and processes.

### DESCRIPTION OF THE DRAWINGS

### Figures

The accompanying drawings, which are incorporated in and constitute a part of this specification, illustrate an embodiment of the Special Search Dog Pack and Process for Faster Dog-Only Search that is preferred. The drawings together with the summary description given above and a detailed description given below serve to explain the principles of the Special Search Dog Pack and Process for Faster Dog-Only Search. It is understood, however, that the Special Search Dog Pack and Process for Faster Dog-Only Search for search and rescue operations is not limited to only the precise arrangements and instrumentalities shown.

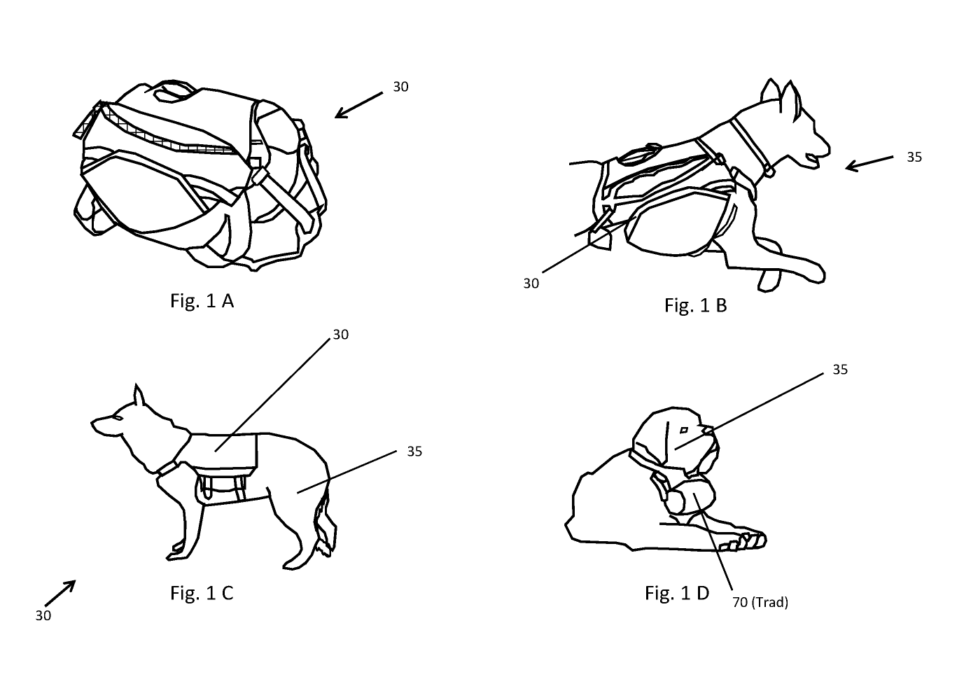

FIGS. 1 A through 1 D are sketches of the general Search and Rescue Device for rescue applications device.

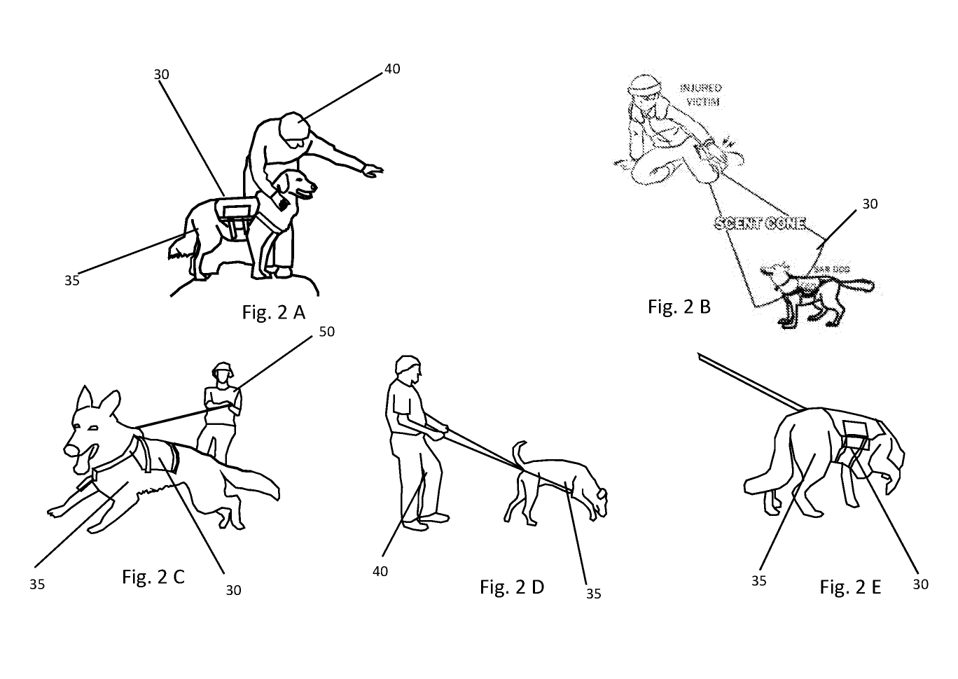

FIGS. 2 A through 2 E are sketches of the general configurations of the rescue device with components and features noted.

### DESCRIPTION OF THE DRAWINGS

### Reference Numerals

The following list refers to the drawings:

TABLE B
Reference numbers

| Ref # | Description |
|---|---|
| 30 | Search and Rescue Device |
| 35 | Animal/Rescue Dog |
| 40 | Human Rescue Trainer |
| 50 | Victim |
| 70 | Traditional Liquid Replenishment |
| 80 | Zone of Victim Scents |

### DETAILED DESCRIPTION OF PREFERRED EMBODIMENT

The present development relates to a Special Search Dog Pack and Process for Faster Dog-Only Search. Particularly this search pack device/product and process is related to a faster search means wherein the search dog has an attached pack with contents that may be carried directly to a victim without the need of an attending person. Once found the victim may communicate back to a search party and/or the search party may quickly and accurately locate the victim for a more precise and faster rescue.

The advantages for the Special Search Dog Pack and Process for Faster Dog-Only Search are listed above in the introduction.

The preferred embodiment of the Special Search Dog Pack and Process for Faster Dog-Only Search—SAR pack—could contains a group of contents from the group consisting of:
Water pouch with gravity water filter
   Water and filter
Power bars
Water proof matches
Space blankets. 84″×56″
Satellite phone
Signal with human only activated switch
Sun screen
Salt
Some first aid
Scent-proof bag
Flashlight
Head cover
Person/s info being sought
Bug repellent
Dog backpack
Lighter
razor knife and a
Signal device for dogs to follow

There is shown in FIGS. 1 and 2 a complete description and operative embodiment of the Special Search Dog Pack and Process for Faster Dog-Only Search device and process. In the drawings and illustrations, one notes well that the FIGS. 1 and 2 demonstrate the general configuration and use of this product and process. The various example uses are in the operation and use section, below.

The accompanying drawings, which are incorporated in and constitute a part of this specification, illustrate an embodiment of the Special Search Dog Pack and Process for Faster Dog-Only Search 30 that is preferred. The drawings together with the summary description given above and a detailed description given below serve to explain the principles of the Special Search Dog Pack and Process for Faster Dog-Only Search 30. It is understood, however, that the Special Search Dog Pack and Process for Faster Dog-Only Search 30 is not limited to only the precise arrangements and instrumentalities shown. Other examples of search and rescue contents, processes and uses are still understood by one skilled in the art of search and rescue pack devices and processes to be within the scope and spirit shown here.

FIGS. 1 A through 1 D are sketches of the general Search and Rescue Device 30 for rescue applications device. Demonstrated in these views are the Search and Rescue Device 30, Animal/Rescue Dog 35, and Traditional Liquid replenishment 70.

FIGS. 2 A through 2 E are sketches of the general configurations of the rescue device 30 with components and features noted. These sketches show the Search and Rescue Device 30; an Animal/Rescue Dog 35; a Human Rescue Trainer 40; a Victim 50; the Traditional Liquid Replenishment 70; and a Zone of Victim Scents 80. In FIG. 2 B the SAR dogs find missing persons, search disaster areas for survivors and bodies and locate evidence at crime scenes, all by focusing on the smell of a human being. To people, this may seem like a difficult task. But to dogs, whose sense of smell is about 40 times stronger than a person's, it's a snap. To a dog, the scent of a human is as powerful and distinctive as the smell of a freshly baked apple pie is to a person. Human beings are smelly creatures—they constantly shed dead skin cells called rafts, which contain bacteria and smell distinctly human. While it's impossible to know for sure, most experts believe that SAR dogs are smelling these rafts, which form a “scent cone” that the dog can easily pinpoint, when they're performing a search. Everyone's skin cells smell unique, which is how a dog can smell an item of clothing and search specifically for the last person who wore it.

The details mentioned here are exemplary and not limiting. Other specific components and manners specific to describing a Special Search Dog Pack and Process for Faster Dog-Only Search 30 may be added as a person having ordinary skill in the field of search and rescue pack devices and their uses well appreciates.

### Operation of the Preferred Embodiment

The Special Search Dog Pack and Process for Faster Dog-Only Search 30 has been described in the above embodiment. The manner of how the device operates is described below. One notes well that the description above and the operation described here must be taken together to fully illustrate the concept of the Special Search Dog Pack and Process for Faster Dog-Only Search 30. The preferred embodiment of the Special Search Dog Pack and Process for Faster Dog-Only Search—SAR pack—contains a group of contents from the group consisting of:
Water pouch with gravity water filter
   Water and filter
Power bars
Water proof matches
Space blankets. 84″×56″
Satellite phone
Signal with human only activated switch
Sun screen
Salt
Some first aid
Scent-proof bag
Flashlight
Head cover
Person/s info being sought
Bug repellent
Dog backpack
Lighter
razor knife and a
Signal device for dogs to follow

The Special Search Dog Pack and Process for Faster Dog-Only Search 30 operates with various commands to the search dogs:
Return.
Return if not on a sent.
Stay.
Follow other dog/s.
Split from other dog/s.
Follow helicopter for pickup.
Circle back.
If no sent, follow tree line, follow river,
   head to higher/lower ground, follow other scents like smoke, food scents, etc.
Bark loudly.
Hide.
Signal alarm if pouch becomes detached.

The handler can send and receive signals through the satellite phone. The signals received back to handler could be such as:
Return.
   Return if not on a scent.
   Stay.
   Follow other dog/s.
   Split from other dog/s.
   Follow helicopter for pickup.
   Circle back.
   If no scent, follow tree line, follow river,
      head to higher/lower ground, follow other scents like smoke, food scents, etc.
   Bark loudly.
   Hide.
   Rest
   Signal alarm if pouch becomes detached.
      Signal if pack falls off.
      Signal if dog barks for different reasons. Ex: Scent ends, danger, snow or water too deep, etc. . . . .

When a person is deemed missing, instead of assembling a search team of people and dogs:
Beacon pings as dog and handler get closer to one another.
Dog stops and stays when a person is found no matter what shape they're in.
GPS tracks the dogs.
Dogs probably spend more energy pulling against the handler.
Dog returns at set point if their device commanding them fails.
Camera attached and remotely turned on to save on battery life

When watching videos of S&R with dogs, it seems that the dogs are pulling against the trainer while the trainer is pulling back expending unneeded energy from both dog and handler. The dogs seem, to me to be able to leave the trainer far behind while staying on the scent. With this new device and process, the backpacks would be preloaded and ready to be put on the dogs in seconds then loaded into the transport. (See contents); the dog's pack easily converts into fanny pack for humans; the dogs would be transported to where someone was missing; the dogs would be given a scent or find a scent and then let loose; the dogs could be given commands. (See commands); the pouch converts into a fanny pack for humans; there are specific command signals for dogs; the pack has a unit that only a humans can turn on; a signal is given off when a dog has been at certain location for predetermined amount of time; a remote activated satellite phone camera and video is included; a clear protective pouch in on dog's pouch for the satellite phone; and the pack is loaded with essentials for survival.

Many uses are anticipated for the Special Search Dog Pack and Process for Faster Dog-Only Search 30. Some examples, and not limitations, are shown in the following List:
An overdue hiker in a wilderness are
A missing child
To help determine if an article was worn by a subject
To help determine if a subject was in an area

WHAT SEARCH DOG TEAMS ARE ABLE TO DO: Trailing dogs are trained to follow the path that a missing person has taken. Similar to traditional “tracking” dogs, these dogs require a properly preserved scent guide and should not be distracted by other people in the area. These dogs usually work on long leashes. Trailing dogs most frequently work trails that are several days old. Area search dogs are trained to find any human scent in an area. These dogs work most frequently off-leash and can cover large areas. Search dogs can be helpful in a variety of situations in the wilderness. When someone is reported lost or overdue, volunteer search and rescue (SAR) dog teams are available to respond, day or night, to help in the search effort. SAR dogs can find: Children lost in the wilderness, parks or hidden in shrubbery around houses; Old people who have wandered away from homes and hospitals; Hikers and hunters lost in the woods; Victims of drowning accidents; Victims of avalanche, earthquake, flood, explosion, fire, train wrecks, plane crashes, tornadoes and other disasters. Also the SAR dogs could be let out of at both termination points of a trail or search zone—at the end of trail and simultaneously at the beginning. Just in case they got almost to the far end of the trail. A dog with handler can average 2 mph so in 6 hours, they could cover 12 miles before their 2 hour rest. A handler in good shape could hike 12 miles in an 8 hour period with a two hour rest for him and the dog. A SAR dog by itself can cover 50 miles in a day with the pack.

With this description it is to be understood that the Special Search Dog Pack and Process for Faster Dog-Only Search. Unless defined otherwise, all technical and scientific terms used herein have the same meaning as commonly understood by one of ordinary skills in the art to which these inventions belong. Although any methods and materials similar or equivalent to those described herein can also be used in the practice or testing of the present inventions, the preferred methods and materials are now described. All patents and publications mentioned herein, including those cited in the background of the application, are hereby incorporated by reference to disclose and describe the methods and/or materials in connection with which the publications are cited.

The publications discussed herein are provided solely for their disclosure prior to the filing date of the present application. Nothing herein is to be construed as an admission that the present inventions are not entitled to antedate such publication by virtue of prior invention. Further, the dates of publication provided may be different from the actual publication dates which may need to be independently confirmed.

Other embodiments of the invention are possible. Although the description above contains much specificity, these should not be construed as limiting the scope of the invention, but as merely providing illustrations of some of the presently preferred embodiments of this invention. It is also contemplated that various combinations or sub-combinations of the specific features and aspects of the embodiments can be made and still fall within the scope of the inventions. It should be understood that various features and aspects of the disclosed embodiments can be combined with or substituted for one another in order to form varying modes of the disclosed inventions. Thus, it is intended that the scope of at least some of the present inventions herein disclosed should not be limited by the particular disclosed embodiments described above.

Thus the scope of this invention should be determined by the appended claims and their legal equivalents. Therefore, it will be appreciated that the scope of the present invention fully encompasses other embodiments which may become obvious to those skilled in the art and that the scope of the present invention is accordingly to be limited by nothing other than the appended claims, in which reference to an element in the singular is not intended to mean “one and only one” unless explicitly so stated, but rather “one or more.” All structural, chemical, and functional equivalents to the elements of the above-described preferred embodiment that are known to those of ordinary skill in the art are expressly incorporated herein by reference and are intended to be encompassed by the present claims. Moreover, it is not necessary for a device or method to address each and every problem sought to be solved by the present invention for it to be encompassed by the present claims. Furthermore, no element, component, or method step in the present disclosure is intended to be dedicated to the public regardless of whether the element, component, or method step is explicitly recited in the claims.

The terms recited in the claims should be given their ordinary and customary meaning as determined by reference to relevant entries (e.g., definition of “plane” as a carpenter's tool would not be relevant to the use of the term “plane” when used to refer to an airplane, etc.) in dictionaries (e.g., widely used general reference dictionaries and/or relevant technical dictionaries), commonly understood meanings by those in the art, etc., with the understanding that the broadest meaning imparted by any one or combination of these sources should be given to the claim terms (e.g., two or more relevant dictionary entries should be combined to provide the broadest meaning of the combination of entries, etc.) subject only to the following exceptions: (a) if a term is used herein in a manner more expansive than its ordinary and customary meaning, the term should be given its ordinary and customary meaning plus the additional expansive meaning, or (b) if a term has been explicitly defined to have a different meaning by reciting the term followed by the phrase “as used herein shall mean” or similar language (e.g., “herein this term means,” “as defined herein,” “for the purposes of this disclosure [the term] shall mean,” etc.). References to specific examples, use of “i.e.,” use of the word “invention,” etc., are not meant to invoke exception (b) or otherwise restrict the scope of the recited claim terms. Other than situations where exception (b) applies, nothing contained herein should be considered a disclaimer or disavowal of claim scope. Accordingly, the subject matter recited in the claims is not coextensive with and should not be interpreted to be coextensive with any particular embodiment, feature, or combination of features shown herein. This is true even if only a single embodiment of the particular feature or combination of features is illustrated and described herein. Thus, the appended claims should be read to be given their broadest interpretation in view of the prior art and the ordinary meaning of the claim terms.

As used herein, spatial or directional terms, such as “left,” “right,” “front,” “back,” and the like, relate to the subject matter as it is shown in the drawing FIGS. However, it is to be understood that the subject matter described herein may assume various alternative orientations and, accordingly, such terms are not to be considered as limiting. Furthermore, as used herein (i.e., in the claims and the specification), articles such as “the,” “a,” and “an” can connote the singular or plural. Also, as used herein, the word “or” when used without a preceding “either” (or other similar language indicating that “or” is unequivocally meant to be exclusive—e.g., only one of x or y, etc.) shall be interpreted to be inclusive (e.g., “x or y” means one or both x or y). Likewise, as used herein, the term “and/or” shall also be interpreted to be inclusive (e.g., “x and/or y” means one or both x or y). In situations where “and/or” or “or” are used as a conjunction for a group of three or more items, the group should be interpreted to include one item alone, all of the items together, or any combination or number of the items. Moreover, terms used in the specification and claims such as have, having, include, and including should be construed to be synonymous with the terms comprise and comprising.

Unless otherwise indicated, all numbers or expressions, such as those expressing dimensions, physical characteristics, etc. used in the specification (other than the claims) are understood as modified in all instances by the term “approximately.” At the very least, and not as an attempt to limit the application of the doctrine of equivalents to the claims, each numerical parameter recited in the specification or claims which is modified by the term “approximately” should at least be construed in light of the number of recited significant digits and by applying ordinary rounding techniques.

What is claimed is:

1. A special search dog pack and process for faster dog-only search that contains a group of contents from the group consisting of:
(a) subsistence items;
(b) survival items;
(c) communication items; and
(d) first aid items.

2. The subsistence items according to claim 1 which are selected from the group consisting of Water pouch with gravity water filter, water and filter, and power bars.

3. The survival items according to claim 1 which are selected from the group consisting of water proof matches, space blankets (example 84″×56″), flashlight, head cover, insect repellent, lighter, and razor knife.

4. The communication items according to claim 1 which are selected from the group consisting of phone (cell or satellite), signal transmitter, and flares.

5. The signal transmitter according to claim 4 wherein a signal transmits a GPS location.

6. The first-aid items according to claim 1 which are selected from the group consisting of a first aid kit with medical and immediate care items.

7. A special search dog pack and process for faster dog-only search that contains a group of contents from the group consisting of:
water pouch with gravity water filter
water and filter;
power bars;
water proof matches;
space blankets. 84″×56″;
satellite phone;
signal with human only activated switch;
sun screen;
salt;
some first aid;
scent-proof bag;
flashlight;
head cover;
person/s info being sought;
bug repellent;
dog backpack;
lighter;
razor knife; and a
a GPS signal device for dogs to follow.
